(19) United States
(12) Patent Application Publication
(10) Pub. No.: US 2006/0118582 A1
(43) Pub. Date: Jun. 8, 2006

(54) Dropper

(76) Inventors: Kuei-Chun Hsu-Yeh, Taiping City (TW); Pei-Yu Chiang, Tanzi Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/002,312

(22) Filed: Dec. 3, 2004

(51) Int. Cl. B65D 47/18; B05B 11/06

(52) U.S. Cl. 222/420; 222/633

(57) ABSTRACT

A dropper includes an integrally portion including a cap and a bulb portion integrally formed with each other. The cap is made of hard material and the bulb portion is made of soft material. A pipette centrally and longitudinally extends through cap and partially received in the bulb portion. The soft bulb portion can be easily compressed and drain the air in the dropper for promoting the sucking range of the dropper, and the integral portion can effectively prevent seepage between the cap and the bulb portion.

### BACKGROUND OF THE INVENTION

1. Field of the Invention

The present invention relates to a dropper, and more particularly to a dropper includes a cap and a bulb portion that are integrally formed.

2. Description of Related Art

A conventional one-piece pipette in accordance with the prior art shown in FIGS. 6 and 7 comprises pipette portion (60), a cap (50) and a bulb portion (70) that are simultaneously integrally formed for reducing the time and expense to manufacture the assembly. An end-piece (71) is provided to close an open end of the bulb portion (70). As a result, the materials of the pipette portion (60), the cap (50) and the bulb portion (70) are identical. For a convenient operation and easily mounting the cap (50) to a fluid bottle, the molding material can not be soft such that the transformation of the bulb portion (70) is limited. As well known, the user must to compress the bulb portion (70) to drain the air in the dropper before sucking fluid into the dropper. Consequently, the sucking range of the conventional dropper is little because the transformation of the bulb portion (70) is limited due to the material thereof. In addition, the hard material may split due to an improper manufacturing process so that the fluid may leak out the dropper during operating.

The present invention has arisen to mitigate and/or obviate the disadvantages of the conventional dropper.

### SUMMARY OF THE INVENTION

The main objective of the present invention is to provide an improved dropper that has a great sucking range.

To achieve the objective, the dropper in accordance with the present invention comprises an integrally portion including a cap and a bulb portion integrally formed with each other. The cap is made of hard material and the bulb portion is made of soft material. A pipette centrally and longitudinally extends through cap and partially received in the bulb portion. The soft bulb portion can be easily compressed and drain the air in the dropper for promoting the sucking range of the dropper, and the integral portion can effectively prevent seepage between the cap and the bulb portion

Further benefits and advantages of the present invention will become apparent after a careful reading of the detailed description with appropriate reference to the accompanying drawings.

### BRIEF DESCRIPTION OF THE DRAWINGS

FIG. 1 is a perspective schematic view of a dropper in accordance with the present invention;

FIG. 2 is an exploded perspective view of the dropper in FIG. 1;

FIG. 3 is a cross-sectional view of the dropper in FIG. 1;

FIG. 4 is a perspective schematic view of a second embodiment of the dropper in accordance with the present invention;

FIG. 5 is an exploded perspective view of the dropper in FIG. 4;

FIG. 6 is an exploded perspective view of a conventional dropper in accordance with the prior art; and

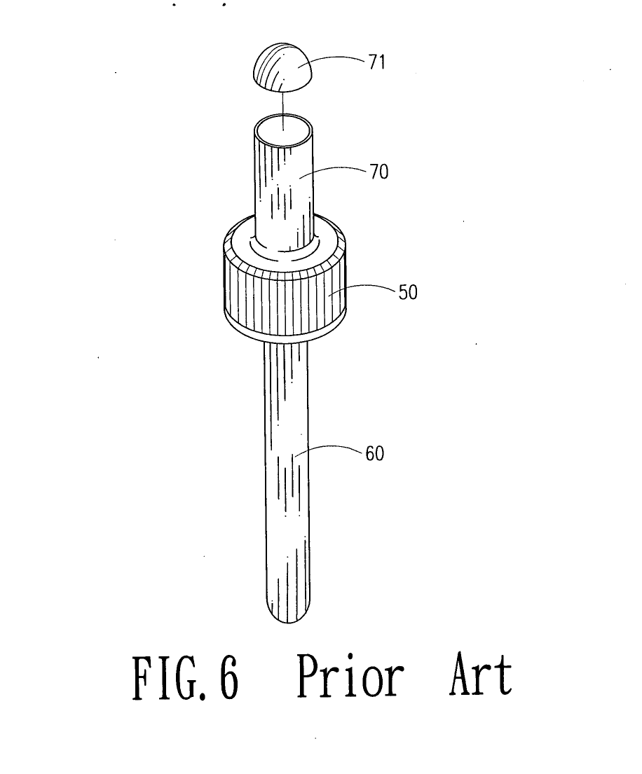

FIG. 7 is a perspective view of the conventional dropper in accordance with the prior art.

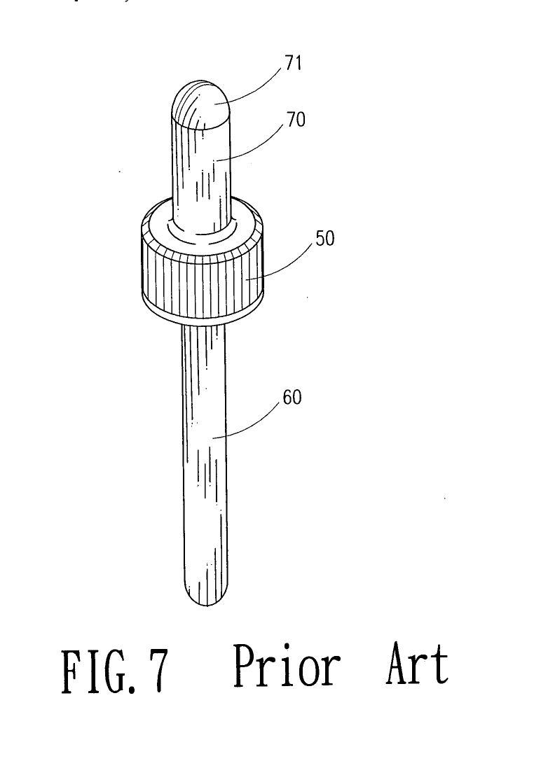

### DETAILED DESCRIPTION OF THE INVENTION

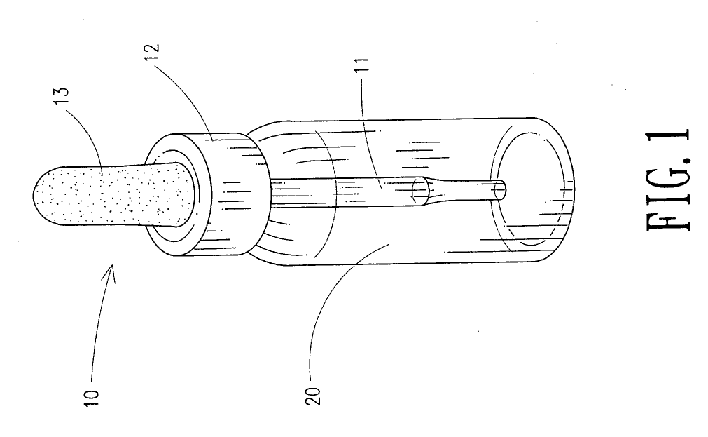

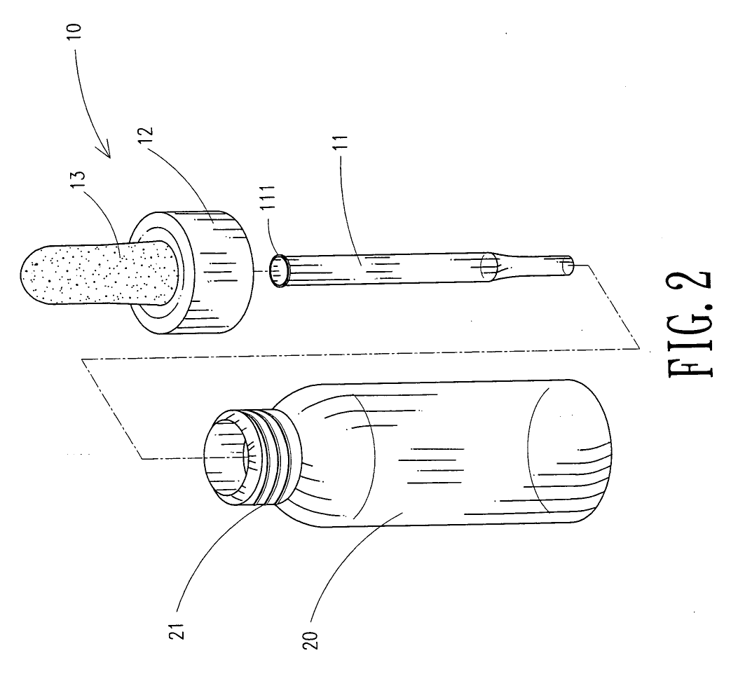

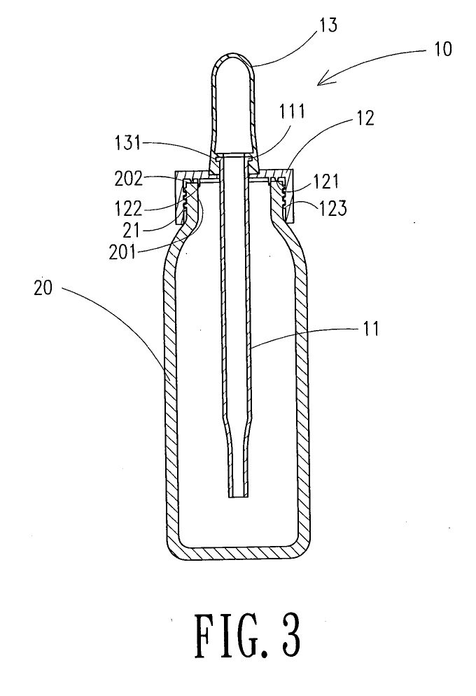

Referring to the drawings and initially to FIGS. 1-3, a dropper in accordance with the present invention comprises an integral portion (10), and a pipette (11) centrally and longitudinally inserted into a bottom of the integral portion (10). The pipette (11) has an annular rib (111) outwardly extending from a top of the pipette (11).

The integral portion (10) includes an n-shaped cap (12) and a bulb portion (13) integrally formed with each other by injection molding and centrally corresponding to each other. The cap (12) is made of hard material and the bulb portion (13) is made soft material. In the preferred embodiment of the present invention, the soft material can be rubber or latex. The cap (13) is firstly formed and the bulb portion (13) is secondarily formed during manufacturing the dropper of the present invention.

The bulb portion (13) has a groove (131) defined in an inner periphery thereof for airtightly receiving the annular rib (111) of the pipette (11) after the pipette (11) extending through the cap (12) and promoting the connection between the integral portion (10) and the pipette (11). The cap (12) includes an annular sealant (121) downward extending from a bottom of the cap (12), a skirt (122) downward extending from the bottom of the cap (12) and a threaded portion (123) formed on an inner periphery of the cap (12). The annular sealant (121) is provided to airtightly abut a distal end (202) of a bottle (20), which contains fluid, for preventing a seepage and the skirt (122) is provided to laterally abut an inner periphery (201) of the top of the bottle (20) for ensuring the cap (12) being longitudinally mounted to the bottle (20) when the threaded portion (123) of the cap (12) is screwed onto a threaded portion (21) that is formed on the top of the bottle, and the pipette (11) is inserted into the bottle (20).

As described above, the sucking range of the dropper in accordance with the present invention is greater than that of the conventional dropper because the soft bulb portion (13) can be easily compressed and drain the air in the dropper. In addition, the integral portion (10) of the present invention can effectively prevent seepage between the cap (12) and the bulb portion (13).

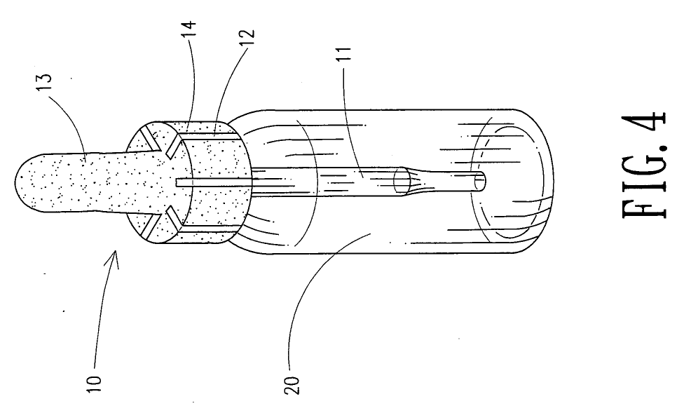

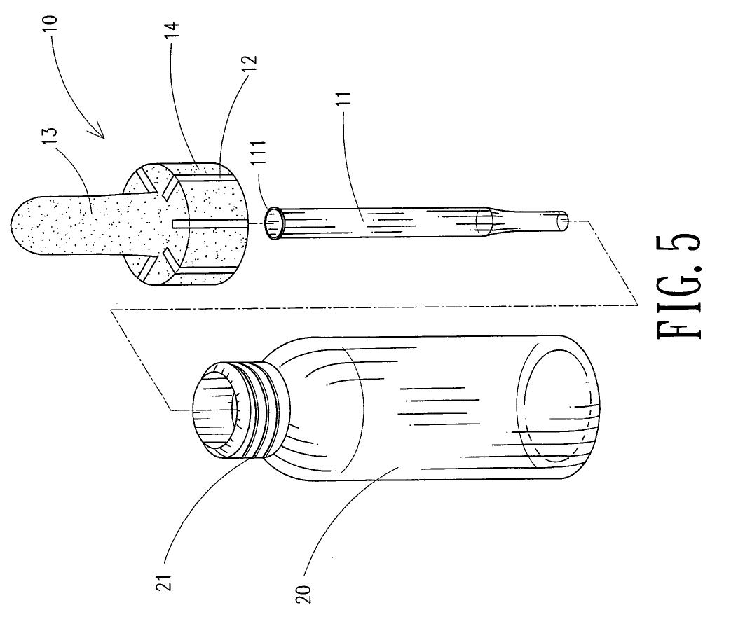

With reference to FIGS. 4 and 5 that show a second embodiment of the dropper in accordance with the present invention, a series of grooves (not numbered) is defined in an outer periphery of the cap (12) such that the melted soft material flows into the series of grooves in the cap (12) when molding the bulb portion (13). As a result, the soft material in the series of groove in the cap (12) provides an anti-slip effect to the cap (12) when the integral portion (10) is screwed onto the threaded portion (21) of the bottle (20).

Although the invention has been explained in relation to its preferred embodiment, it is to be understood that many other possible modifications and variations can be made without departing from the spirit and scope of the invention as hereinafter claimed.

What is claimed is:

1. A dropper comprising:
an integrally portion including a cap and a bulb portion integrally formed with each other, the cap made of hard material and the bulb portion made of soft material; and
a pipette centrally and longitudinally extending through cap and partially received in the bulb portion;
whereby the soft bulb portion can be easily compressed and drain the air in the dropper for promoting the sucking range of the dropper, and the integral portion can effectively prevent seepage between the cap and the bulb portion.

2. The dropper as claimed in claim 1, wherein the cap and the bulb portion are integrally formed with each other by sequential injection molding.

3. The dropper as claimed in claim 1, wherein the soft material is rubber.

4. The dropper as claimed in claim 1, wherein the soft material is latex.

5. The dropper as claimed in claim 1, wherein a series of grooves is defined in an outer periphery of the cap such that the melted soft material flows into the series of grooves in the cap when molding the bulb portion and the soft material in the series of groove in the cap provides an anti-slip effect to the cap when the integral portion is adapted to be screwed onto bottle that contains fluid.

6. The dropper as claimed in claim 5, wherein the cap and the bulb portion are integrally formed with each other by sequential injection molding

7. The dropper as claimed in claim 5, wherein the soft material is rubber.

8. The dropper as claimed in claim 5, wherein the soft material is latex.
